(19) United States
(12) Patent Application Publication
(10) Pub. No.: US 2025/0184796 A1
(43) Pub. Date: Jun. 5, 2025

(54) APPARATUS AND METHOD FOR RADIO ACCESS NETWORK NODE OPTIMISATION IN A WIRELESS COMMUNICATION SYSTEM

(71) Applicant: Samsung Electronics Co., Ltd., Suwon-si (KR)

(72) Inventors: Ashutosh KAUSHIK, Bangalore (IN); Deepanshu GAUTAM, Bangalore (IN); Jaijin LIM, Suwon-si (KR)

(21) Appl. No.: 18/960,507

(22) Filed: Nov. 26, 2024

(30) Foreign Application Priority Data
Nov. 30, 2023 (IN) 202341081399
Oct. 17, 2024 (IN) 2023 41081399

(51) Int. Cl. H04W 24/10; H04L 43/0888

(52) U.S. Cl. CPC H04W 24/10; H04L 43/0888

(57) ABSTRACT

The disclosure relates to a fifth generation (5G) or sixth generation (6G) communication system for supporting a higher data transmission rate. A method and a system for radio access network (RAN) node optimization in a wireless network are provided. The method includes receiving, by a producer device, a create managed object instance (MOI) request for collecting performance metrics, from a consumer device, wherein the create MOI request comprises a plurality of attributes for collecting the performance metrics, wherein the performance metrics include at least one of measurements and key performance indicators (KPIs) collected at at least one of a gNodeB (gNB) and a central unit user plane (CU-UP) end of a next generation user plane (N3/NgU) interface of the producer device, performing, by the producer device, collection of the performance metrics at the at least one of the gNB and the CU-UP end of the N3/NgU interface of the producer device based on plurality of attributes received in the create MOI request, wherein the measurements include at least one of a measurement of number of octets of incoming general packet radio service (GPRS) tunneling protocol (GTP) data packets on the N3/NgU interface from a user plane Function (UPF) to the RAN, and a measurement of number of octets of outgoing GTP data packets on the N3/NgU interface from the RAN to the UPF, wherein the KPIs collected include at least one of a downstream throughput for a network slice, and an upstream throughput for a network slice at the at least one of the gNB and the CU-UP end of the N3/NgU interface, and sending, by the producer device, the collected performance metrics to the consumer device to optimize at least one of gNB configurations and CU-UP configurations at the producer device based on the performance metrics received from the producer device.

### CROSS-REFERENCE TO RELATED APPLICATION(S)

This application is based on and claims priority under 35 U.S.C. § 119(a) of an Indian Provisional patent application number 202341081399, filed on Nov. 30, 2023, in the Indian Patent Office, and of an Indian Complete patent application number 202341081399, filed on Oct. 17, 2024, in the Indian Patent Office, the disclosure of each of which is incorporated by reference herein in its entirety.

### BACKGROUND

### 1. Field

The disclosure relates to wireless communication. More particularly, the disclosure relates to radio access network (RAN) node optimisation in a wireless network.

### 2. Description of Related Art

Fifth generation (5G) mobile communication technologies define broad frequency bands such that high transmission rates and new services are possible, and can be implemented not only in “Sub 6 GHz” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The fifth generation (5G) communication system, comprising a 5G access network (AN), a 5G Core Network, and user equipment (UE) as specified in TS 23501, is engineered to optimize support for a variety of communication services, traffic loads, and user communities. Notably, the system aims to meet the stringent requirements of vehicle to everything (V2X) services, which demand high data rates, reliability, low latency, and high speed. Additionally, the system facilitates enhanced mobile broadband (eMBB) through fixed mobile convergence (FMC) and supports network slicing to cater to diverse service needs. The 5G system is also designed to handle massive IoT connections, such as those found in smart homes and smart grids, which require support for numerous high-density IoT devices.

Network slicing is a pivotal feature within the 5G framework, allowing operators to create dedicated logical networks on shared infrastructure. This approach enables customized functionality tailored to specific customer needs, moving away from the traditional one-size-fits-all model. Network slices can be dynamically allocated for specific purposes, with some slices being temporary (e.g., providing eMBB service to a broadcaster for a live event) and others being long-term (e.g., providing eMBB services to a hospital).

Despite the advancements, several challenges remain in effectively managing and monitoring network slices, particularly from the perspective of the radio access network (RAN). Current standards, such as those outlined in 3GPP TS 28530, 28531, and GSMA NG116 (Version 9 Apr. 2023), provide definitions and key performance indicators (KPIs) for downstream and upstream throughput per network slice. These KPIs, however, are primarily focused on the core network subnet slices and rely on measurements taken at the user plane functions (UPFs), which are the endpoints of the N3/NgU interface.

One significant problem is the lack of a standardized mechanism to measure or monitor throughput on the N3/NgU interface for RAN slices or slice subnets across RAN aggregation points, such as gNodeBs (gNBs) and central unit user planes (CU-UPs). Consequently, the RAN network slice subnet management function (NSSMF) cannot ascertain the throughput on the N3/NgU interface provided by the constituent gNBs and CU-UPs for a particular slice. Additionally, a consumer NSSMF within the core network slice subnet may require knowledge of the N3/NgU throughput at the RAN end (i.e., at the gNB/CU-UP). However, due to the absence of standardized measurement at the RAN end of the N3/NgU interface, there is no standardized method to relay this information back to the core network slice subnet consumer.

Furthermore, the throughput at the UPF end of the N3/NgU interface may differ from that at the gNB/CU-UP end of the N3/NgU interface. For effective gNB/CU-UP capacity planning, it is crucial to calculate performance metrics at the gNB/CU-UP end of the N3/NgU interface. Therefore, there is a pressing need to define these metrics to ensure accurate and efficient network performance monitoring and management.

The above information is presented as background information only to assist with an understanding of the disclosure. No determination has been made, and no assertion is made, as to whether any of the above might be applicable as prior art with regard to the disclosure.

Aspects of the disclosure are to address at least the above-mentioned problems and/or disadvantages and to provide at least the advantages described below. Accordingly, an aspect of the disclosure is to provide a useful alternative to overcome the inter-device connection setup problems and synchronization issues inherent in the current 5G network slicing management framework.

Another aspect of the disclosure is to provide a system and method for RAN node optimization in a wireless network. In the proposed solution, gNB configurations and CU-UP configurations at the RAN node are optimized based on the performance metrics collected at a gNB and/or a CU-UP end of the next generation user plane (N3/NgU) interface of the RAN node.

Another aspect of the disclosure is to provide measurement at the gNB/CU-UP end to obtain the number of octets of outgoing general packet radio service (GPRS) tunneling protocol (GTP) data packets on the N3/NgU interface for a network & slice.

Another aspect of the disclosure is to provide measurement at the gNB/CU-UP end to obtain the number of octets of incoming GTP data packets on the N3/NgU interface for a network & slice.

Another aspect of the disclosure is to define new KPIs to measure downstream throughput and upstream throughput of a network slice on the N3/NgU interface at the gNB and/or the CU-UP end. Measuring throughput will enable a RAN NSSMF to be informed about the throughput on the N3/NgU interface being provided by the gNBs and the CU-UPs for a particular slice.

Another aspect of the disclosure is to define new KPIs to measure downstream throughput and upstream throughput of a network slice on the N3/NgU interface at the gNB and/or the CU-UP end. Measuring throughput will enable a core network NSSMF to be informed about the throughput on the N3/NgU interface being provided by the gNBs and the CU-UPs for a particular slice.

Additional aspects will be set forth in part in the description which follows and, in part, will be apparent from the description, or may be learned by practice of the presented embodiments.

In accordance with an aspect of the disclosure, a method for radio access network (RAN) node optimization in a wireless network is provided. The method includes receiving, by a producer device, a create managed object instance (MOI) request for collecting performance metrics, from a consumer device, wherein the create MOI request includes a plurality of attributes for collecting the performance metrics, wherein the performance metrics include at least one of measurements and KPIs collected at at least one of a gNB and a CU-UP end of a N3/NgU interface of the producer device, performing, by the producer device, collection of the performance metrics at the at least one of the gNB and the CU-UP end of the N3/NgU interface of the producer device based on the plurality of attributes received in the create MOI request, wherein the measurements include at least one of a measurement of number of octets of incoming general packet radio service (GPRS) tunneling protocol (GTP) data packets on the N3/NgU interface from a user plane Function (UPF) to the RAN, and a measurement of number of octets of outgoing GTP data packets on the N3/NgU interface from the RAN to the UPF, wherein the KPIs collected include at least one of a downstream throughput for a network slice, and an upstream throughput for a network slice at the at least one of the gNB and the CU-UP end of the N3/NgU interface, and sending, by the producer device, the collected performance metrics to the consumer device to optimize at least one of gNB configurations and CU-UP configurations at the producer device based on the performance metrics received from the producer device.

In an embodiment of the disclosure, the producer device determines whether a condition for the measurements is met, wherein the condition for the measurements comprises a reception and/or a transmission of a GTP-U data Protocol Data Unit (PDU) by the gNB and the CU-UP on the N3/NgU interface. The producer device performs the measurements at the gNB and the CU-UP end of the N3/NgU interface when the condition is met.

In an embodiment of the disclosure, the producer device splits the measurements into sub-counters per single network slice selection assistance information (S-NSSAI), wherein each of the measurements is a single integer value, wherein the number of measurements is equal to the number of supported S-NSSAIs when optional S-NSSAI sub-counter measurements are performed.

In an embodiment of the disclosure, the measurements comprise a measurement name representing the number of octets of incoming GTP data packets and outgoing GTP data packets on the N3/NgU interface at the gNB and the CU-UP end, wherein the incoming GTP data packets and the outgoing GTP data packets are generated by a GTP-U protocol entity on the N3/NgU interface. The collection method for the measurement is cumulative counter (CC), and wherein the measurement is valid for a packet switching network.

In an embodiment of the disclosure, the producer device determines the downstream throughput for a network slice at the gNB and the CU-UP end of the N3/NgU interface. The producer device determines a KPI name representing the downstream throughput of the network slice instance at the gNB and CU-UP end on the N3/NgU interface. Further, the producer device determines a total number of downstream octets of the GTP data packets provided over the N3/NgU interface from the UPF to the RAN related to the single network slice. The producer device divides the determined total number of downstream octets of the GTP data packets by a predetermined period to determine the downstream throughput.

In an embodiment of the disclosure, the producer device determines the upstream throughput for a network slice at the gNB and the CU-UP end of the N3/NgU interface. The producer device determines a KPI name representing the upstream throughput of the network slice instance at the gNB and CU-UP end on the N3/NgU interface. Further, the producer device determines a total number of upstream octets of the GTP data packets provided over the N3/NgU interface from the UPF to the RAN related to the single network slice. The producer device divides the determined total number of upstream octets of the GTP data packets by a predetermined period to determine the upstream throughput.

In an embodiment of the disclosure, the consumer device determines that the upstream throughput and the downstream throughput is less than a target value based on the performance metrics. The consumer device sends a reconfiguration request to the producer device to modify or update MOI attributes of the gNB and the CU-UP when the upstream throughput and/or the downstream throughput is less than the target value.

In an embodiment of the disclosure, the consumer device predicts that the upstream throughput and/or the downstream throughput will be reduced to less than a target value based on the performance metrics. The consumer device sends a request message to create assurance closed control loop (ACCL) to the producer device when the upstream throughput and/or downstream throughput is predicted to be reduced to less than the target value.

In an embodiment of the disclosure, the of attributes for collecting the performance metrics comprises objectInstances, a reportingCtrl, performanceMetrics, and a granularityPeriod.

In accordance with another aspect of the disclosure, a method for radio access network (RAN) node optimization in a wireless network is provided. The method includes sending, by a consumer device, a create MOI request for collecting performance metrics to a producer device, wherein the create MOI request includes a plurality of attributes for collecting performance metrics, wherein the performance metrics include at least one of measurements and KPIs collected at at least one of a gNB and a CU-UP end of a N3/NgU interface of the producer device, receiving, by the consumer device, the performance metrics from the producer device, wherein the measurements include at least one of a measurement of number of octets of incoming GTP data packets on the N3/NgU interface from a UPF to the RAN, and a measurement of number of octets of outgoing GTP data packets on the N3/NgU interface from the RAN to the UPF, wherein the KPIs collected include at least one of a downstream throughput for a network slice, and an upstream throughput for a network slice at the at least one of the gNB and the CU-UP end of the N3/NgU interface, and optimizing, by the consumer device, at least one of gNB configurations and CU-UP configurations at the producer device based on the performance metrics received from the producer device.

In an embodiment of the disclosure, the measurements comprise a measurement name representing the number of octets of incoming GTP data packets and outgoing GTP data packets on the N3/NgU interface at the gNB and the CU-UP end, wherein the incoming GTP data packets and the outgoing GTP data packets are generated by a GTP-U protocol entity on the N3/NgU interface, wherein the condition for the measurement is reception or transmission of a GTP-U data PDU by the gNB and the CU-UP on the N3/NgU interface of the producer device, wherein the measurement can optionally be split into sub-counters per S-NSSAI.

In accordance with another aspect of the disclosure, a producer device for the radio access network (RAN) node optimization in the wireless network is provided. The producer device includes memory, an input/output (I/O) interface, a communication processor, and a RAN node optimization controller communicatively coupled to the memory, the communication processor, and the I/O interface, wherein the RAN node controller is configured to receive a create MOI request for collecting performance metrics, from a consumer device, wherein the create MOI request includes a plurality of attributes for collecting the performance metrics, wherein the performance metrics includes at least one of measurements and KPIs collected at at least one of a gNB and a CU-UP end of a N3/NgU interface of the producer device, perform collection of the performance metrics at the at least one of the gNB and the CU-UP end of the N3/NgU interface of the producer device based on the plurality of attributes received in the create MOI request, wherein the measurements include at least one of a measurement of number of octets of incoming GTP data packets on the N3/NgU interface from a UPF to the RAN, and a measurement of number of octets of outgoing GTP data packets on the N3/NgU interface from the RAN to the UPF, wherein the KPIs collected include at least one of a downstream throughput for a network slice, and an upstream throughput for a network slice at the at least one of the gNB and the CU-UP end of the N3/NgU interface, and send the collected performance metrics to the consumer device to optimize at least one of gNB configurations and CU-UP configurations at the producer device based on the performance metrics received from the producer device.

In accordance with another aspect of the disclosure, a consumer device for radio access network (RAN) node optimization in a wireless network is provided. The consumer device includes memory, an I/O interface, a communication processor, and a RAN node optimization controller communicatively coupled to the memory, the communication processor, and the I/O interface, wherein the RAN node controller is configured to send a create MOI request for collecting performance metrics to a producer device, wherein the create MOI request includes a plurality of attributes for collecting performance metrics, wherein the performance metrics include at least one of measurements and KPIs collected at at least one of a gNB and a CU-UP end of a N3/NgU interface of the producer device, receive the performance metrics from the producer device, wherein the measurements include at least one of a measurement of number of octets of incoming GTP data packets on the N3/NgU interface from a UPF to the RAN, and a measurement of number of octets of outgoing GTP data packets on the N3/NgU interface from the RAN to the UPF, wherein the KPIs collected include at least one of a downstream throughput for a network slice, and an upstream throughput for a network slice at the gNB and the CU-UP end of the N3/NgU interface, and optimize at least one of gNB configurations and CU-UP configurations at the producer device based on the performance metrics received from the producer device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a producer device for RAN node optimization in a wireless network according to an embodiment of the disclosure;

FIG. 2 is a block diagram of a consumer device for the RAN node optimization in the wireless network according to an embodiment of the disclosure;

FIG. 3 is a sequence diagram that illustrates a method for the RAN node optimization in the wireless network according to an embodiment of the disclosure;

FIG. 4 is a flow diagram that illustrates a method for the RAN node optimization by the producer device in the wireless network according to an embodiment of the disclosure;

FIG. 5 is a flow diagram that illustrates a method for the RAN node optimization by the consumer device in the wireless network according to an embodiment of the disclosure;

FIG. 6 illustrates a structure of a base station according to an embodiment of the disclosure; and

FIG. 7 illustrates a structure of a network entity according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, the various embodiments described herein are not necessarily mutually exclusive, as some embodiments can be combined with one or more other embodiments to form new embodiments. The term “or” as used herein, refers to a non-_exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits, such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports, such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, or the like, used herein to describe various elements, these elements are not be limited by these terms. These terms are generally used to distinguish one element from another.

In existing methods, the KPIs outlined for the upstream and downstream throughput on the N3/NgU interface per network slice instance are only applicable to core network subnet slices. This is because these KPIs rely on measurements taken at the UPFs, which are the endpoints of the N3/NgU interface associated with specific network slice subnet instances. From the RAN perspective, there is currently no way to measure or monitor throughput on the N3/NgU interface for RAN slices or slice subnets across RAN aggregation points, such as gNBs and CU-UPs. As a result, a RAN NSSMF cannot determine the amount of throughput on the N3/NgU interface being provided by the constituent gNBs and CU-UPs for a particular slice. Additionally, a consumer NSSMF within the core network slice subnet may wish to know the N3/NgU throughput at the RAN end (i.e., at the gNB/CU-UP). However, since this measurement is not standardized at the RAN (gNB/CU-UP) end of the N3/NgU interface, there is no standardized mechanism to relay this information back to the core network slice subnet consumer. Further, the throughput at the UPF end of the N3/NgU interface may be different from the throughput at the gNB/CU-UP end of the N3/NgU interface. For better gNB/CU-UP capacity planning, the performance metric is required to be calculated at the gNB/CU-UP end of the N3/NgU. Hence, it is important to define these metrics.

Unlike existing methods, the proposed solution offers a method and system for optimizing the RAN nodes by incorporating measurement and related throughput KPIs for the RAN slices and slice subnets on the N3/NgU interface of the gNBs and the CU-UPs, which are the endpoints of the N3/NgU interface. With these KPIs in place, the RAN NSSMF can make informed decisions about allocating additional CU-UP resources and instantiating new CU-UPs as needed. Specifically, the solution involves new measurements at the gNB/CU-UP end to capture the number of octets of outgoing general packet radio service (GPRS) tunneling protocol (GTP) data packets on the N3/NgU interface for a specific network and slice, as well as the number of octets of incoming GTP data packets. Additionally, the proposed solution introduces new KPIs to determine both the downstream throughput and the upstream throughput of a network slice on the N3/NgU interface at the gNB/CU-UP end.

Therefore, the proposed solution will allow the RAN to measure and monitor throughput on the N3/NgU interface for each RAN slice and slice subnet across its aggregation points, such as the gNBs and the CU-UPs. With this capability, the RAN NSSMF can determine the amount of throughput on the N3//NgU interface that is being provided by the constituent gNBs and CU-UPs for a specific slice. Further, the proposed solution enables the RAN NSSMF to make informed decisions about where to allocate additional CU-UP resources and to instantiate new CU-UPs if necessary. As a result, better RAN node optimization for the throughput can be achieved with the new measurements and KPIs facilitating the monitoring and maintenance of performance integrity for the slice from the RAN perspective.

Moreover, the introduction of these new KPIs and measurement capabilities at the gNB/CU-UP end will bridge the existing gap between the core network and the RAN in terms of throughput monitoring. This holistic approach ensures that both ends of the N3/NgU interface are accounted for, leading to a more accurate and comprehensive understanding of network performance. The ability to monitor throughput at the RAN end will also enable more precise troubleshooting and performance tuning, thereby enhancing the overall quality of service experienced by end-users. By standardizing these measurements, the proposed solution ensures interoperability and consistency across different network components and vendors, fostering a more robust and reliable network infrastructure.

In addition, the proposed solution's ability to provide real-time throughput data at the RAN end can significantly enhance network agility and responsiveness. Network operators can quickly identify and address bottlenecks or performance issues, ensuring that network slices meet their intended service level agreements (SLAs). This proactive approach to network management not only improves user satisfaction but also optimizes resource utilization, reducing operational costs and improving the efficiency of network operations. Overall, the proposed solution represents a significant advancement in the management and optimization of RAN resources, paving the way for more dynamic and efficient 5G networks.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

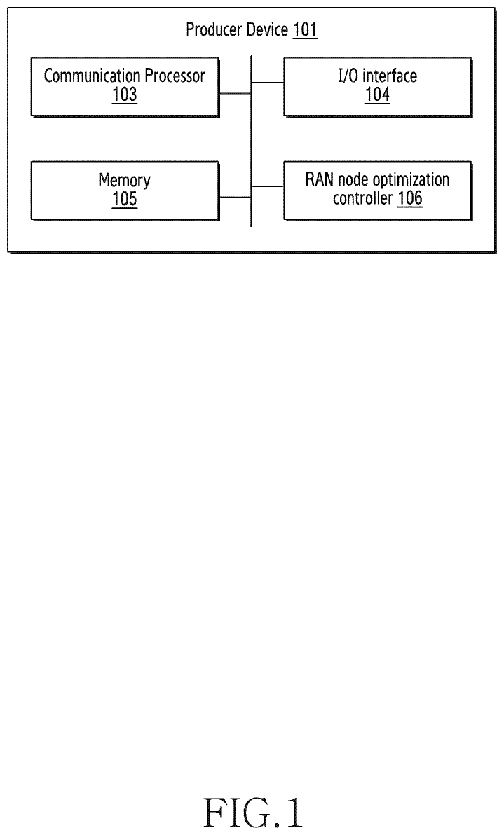

Referring now to the drawings and more particularly to FIGS. 1 through 5, where similar reference characters denote corresponding features consistently throughout the figure, these are shown preferred embodiments.

FIG. 1 is a block diagram of a producer device for the RAN node optimization in the wireless network according to an embodiment of the disclosure.

Referring to FIG. 1, a producer device 101 includes memory 105, a communication processor 103, an Input/Output (I/O) interface 104, and a RAN node optimization controller 106.

The memory 105 is configured to store instructions to be executed by the communication processor 103. The memory 105 can include non-volatile storage elements. Examples of such non-volatile storage elements may include magnetic hard disks, optical disks, floppy disks, flash memories, or forms of electrically programmable memories (EPROM) or electrically erasable and programmable (EEPROM) memories. In addition, the memory 105 may in some examples be considered a non-transitory storage medium. The term non-transitory may indicate that the storage medium is not embodied in a carrier wave or a propagated signal. However, the term non-transitory should not be interpreted that the memory 105 is non-movable. In some examples, the memory 105 is configured to store larger amounts of information. In certain examples, a non-transitory storage medium may store data that can over time change (e.g., in random access memory (RAM) or cache).

The communication processor 103 may include one or a plurality of processors. The one or the plurality of processors may be a general-purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU). The communication processor 103 may include multiple cores and is configured to execute the instructions stored in the memory 105.

The I/O interface 104 transmits the information between the memory 105 and external peripheral devices. The peripheral devices are the input-output devices associated with the network apparatus. The I/O interface 104 receives several pieces of information from a plurality of UEs, network devices, servers, and the like.

In an embodiment of the disclosure, the RAN node optimization controller 106 of the producer device 101 communicates with the processor 103, I/O interface 104, and memory 105 for the RAN node optimization in the wireless network.

The RAN node optimization controller 106 receives the create managed object instance (MOI) request for collecting the performance metrics from the consumer device wherein the create MOI request comprises the attributes for collecting the performance metrics wherein the performance metrics comprise the measurements and the KPIs collected at the gNB and the CU-UP end of the N3/NgU interface of the producer device 101. The RAN node optimization controller 106 performs collection of the performance metrics at the gNB and the CU-UP end of the N3/NgU interface of the producer device 101 based on the attributes received in the create MOI request wherein the performance metrics comprises measurement of the number of octets of the incoming GTP data packets on the N3/NgU interface from the UPF to the RAN, the measurement of the number of octets of the outgoing GTP data packets on the N3/NgU interface from the RAN to the UPF, the KPI of the downstream throughput for a network slice, and the KPI of the upstream throughput for a network slice at the gNB and the CU-UP end of the N3/NgU interface. Further, the RAN node optimization controller 106 sends the collected performance metrics to the consumer device to optimize the gNB configurations and the CU-UP configurations at the producer device 101 based on the performance metrics received from the producer device 101.

In an embodiment of the disclosure, the RAN node optimization controller 106 determines whether a condition for the measurements is met wherein the condition for the measurements comprises a reception and a transmission of a GTP-U data PDU by the gNB and the CU-UP on the N3/NgU interface. The RAN node optimization controller 106 performs the measurements at the gNB and the CU-UP end of the N3/NgU interface when the condition is met. This ensures that the performance metrics are collected only when relevant data traffic is present, thereby optimizing the use of computational resources and ensuring the accuracy of the collected metrics.

In an embodiment of the disclosure, the RAN node optimization controller 106 splits the measurements into sub-counters per S-NSSAI wherein each of the measurements is a single integer value. The number of measurements is equal to the number of supported S-NSSAIs when optional S-NSSAI sub-counter measurements are performed. This granularity allows for a more detailed analysis of the network performance, enabling the identification of specific issues related to individual network slices. By breaking down the measurements into sub-counters, the RAN node optimization controller 106 can provide more precise data, which is crucial for fine-tuning the network configurations.

In an embodiment of the disclosure, the RAN node optimization controller 106 determines the downstream throughput for a network slice at the gNB and the CU-UP end of the N3/NgU interface. The RAN node optimization controller 106 determines a KPI name representing the downstream throughput of the network slice instance at the gNB and CU-UP end on the N3/NgU interface. Further, the RAN node optimization controller 106 determines a total number of downstream octets of the GTP data packets provided over the N3/NgU interface from the UPF to the RAN related to the single network slice. The RAN node optimization controller 106 divides the determined total number of downstream octets of the GTP data packets by a predetermined period to determine the downstream throughput. This calculation is used for assessing the performance of the network slice in terms of data delivery efficiency and can help in making informed decisions for network optimization.

In an embodiment of the disclosure, the RAN node optimization controller 106 determines the upstream throughput for a network slice at the gNB and the CU-UP end of the N3/NgU interface. The RAN node optimization controller 106 determines a KPI name representing the upstream throughput of the network slice instance at the gNB and CU-UP end on the N3/NgU interface. Further, the RAN node optimization controller 106 determines a total number of upstream octets of the GTP data packets provided over the N3/NgU interface from the UPF to the RAN related to the single network slice. The RAN node optimization controller 106 divides the determined total number of upstream octets of the GTP data packets by a predetermined period to determine the upstream throughput. Similar to the downstream throughput, this metric is essential for evaluating the network's ability to handle data sent from the user equipment to the network, ensuring balanced and efficient data flow.

The RAN node optimization controller 106 is an inventive hardware component that is incorporated into the producer device 101 through processing circuitry comprising logic gates, integrated circuits, microprocessors, microcontrollers, memory circuits, passive and active electronic components, optical components, hardwired circuits, or similar technologies. These circuits can be manifested in one or more semiconductor chips or on substrate supports, such as printed circuit boards. This hardware-based approach also allows for faster processing and lower power consumption compared to software-only solutions, making it an ideal choice for modern electronic devices that require both high performance and energy efficiency. The integration of such advanced hardware components ensures that the RAN node optimization controller 106 can handle the demanding requirements of real-time network optimization and performance monitoring.

In an embodiment of the disclosure the components of the RAN node optimization controller 106 may be implemented through an AI model. A function associated with the AI model may be performed through the memory 105 and the processor 103. The one or a plurality of processors controls the processing of the input data in accordance with a predefined operating rule or the AI model stored in the non-volatile memory and the volatile memory. The predefined operating rule or artificial intelligence model is provided through training or learning. This incorporation of AI allows the RAN node optimization controller 106 to adapt to changing network conditions dynamically, making real-time adjustments to optimize performance. The AI model can learn from historical data and predict future network behavior, providing proactive optimization rather than reactive adjustments. This capability significantly enhances the efficiency and reliability of the network, ensuring a high-quality user experience.

Whilst FIG. 1 depicts the hardware components of the producer device 101, it should be noted that alternative embodiments are not confined to these elements. The producer device 101 may comprise a greater or lesser number of hardware components in other embodiments. Additionally, the labels or names assigned to these elements are purely for illustrative purposes and do not restrict the scope of the disclosure. Furthermore, it is possible for one or more components to be merged together to perform the same or a substantially similar function.

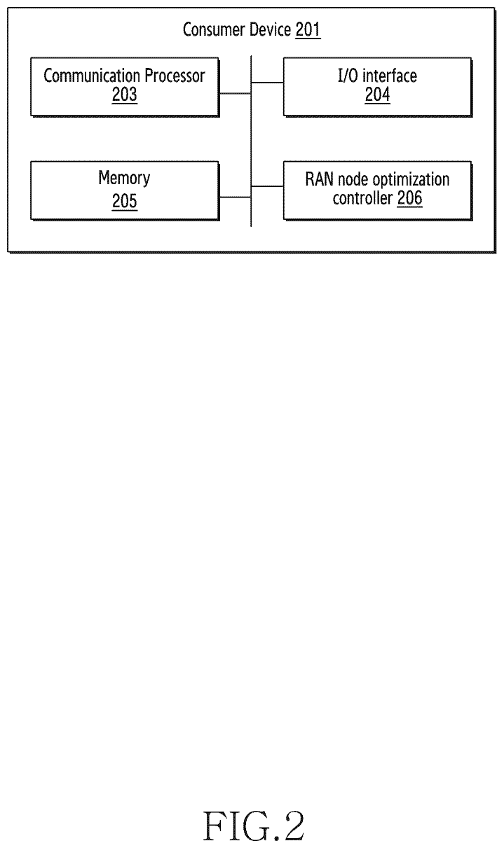

FIG. 2 is a block diagram of a consumer device for the RAN node optimization in a wireless network according to an embodiment of the disclosure.

Referring to FIG. 2, a consumer device 201 includes memory 205, a communication processor 203, an Input/Output (I/O) interface 204, and a RAN node optimization controller 206.

The memory 205 is configured to store instructions to be executed by the communication processor 203. The memory 205 can include non-volatile storage elements. Examples of such non-volatile storage elements may include magnetic hard disks, optical disks, floppy disks, flash memories, or forms of electrically programmable memories (EPROM) or electrically erasable and programmable (EEPROM) memories. In addition, the memory 205 may in some examples be considered a non-transitory storage medium. The term non-transitory may indicate that the storage medium is not embodied in a carrier wave or a propagated signal. However, the term non-transitory should not be interpreted that the memory 205 is non-movable. In some examples, the memory 205 is configured to store larger amounts of information. In certain examples, a non-transitory storage medium may store data that can over time change (e.g., in random access memory (RAM) or cache).

The communication processor 203 may include one or a plurality of processors. The one or the plurality of processors may be a general-purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU). The communication processor 203 may include multiple cores and is configured to execute the instructions stored in the memory 205.

The I/O interface 204 transmits the information between the memory 205 and external peripheral devices. The peripheral devices are the input-output devices associated with the network apparatus. The I/O interface 204 receives several pieces of information from a plurality of UEs, network devices, servers, and the like.

In an embodiment of the disclosure, the RAN node optimization controller 206 of the consumer device 201 communicates with the processor 203, I/O interface 204, and memory 205 for the RAN node optimization in the wireless network.

The RAN node optimization controller 206 sends the create MOI request for collecting the performance metrics to the producer device 101, wherein the create MOI request comprises the attributes for collecting the performance metrics. The RAN node optimization controller 206 receives the performance metrics from the producer device 101, wherein the performance metrics comprise the measurement of the number of octets of the incoming GTP data packets on the N3/NgU interface from the UPF to the RAN, the measurement of the number of octets of the outgoing GTP data packets on the N3/NgU interface from the RAN to the UPF, the KPI of the downstream throughput for a network slice, and the KPI of the upstream throughput for the network slice at the gNB and the CU-UP end of the N3/NgU interface. Further, the RAN node optimization controller 206 optimizes the gNB configurations and the CU-UP configurations at the producer device 101 based on the performance metrics received from the producer device 101.

In an embodiment of the disclosure, the RAN node optimization controller 206 determines that the upstream throughput and/or the downstream throughput is less than a target value based on the performance metrics. The RAN node optimization controller 206 sends a reconfiguration request to the producer device 101 to modify or update MOI attributes of the gNB and the CU-UP when the upstream throughput and/or the downstream throughput is less than the target value. This reconfiguration process ensures that the network maintains optimal performance levels, thereby enhancing the user experience by minimizing latency and maximizing data transfer rates. The controller's ability to dynamically adjust configurations based on real-time performance data is crucial for maintaining the efficiency and reliability of the network.

In another embodiment of the disclosure, the RAN node optimization controller 206 predicts that upstream throughput and/or the downstream throughput will be reduced to less than a target value based on the performance metrics. The RAN node optimization controller 206 sends a request message to create ACCL to the producer device 101 when the upstream throughput and/or downstream throughput is predicted to be reduced to less than the target value. This predictive capability allows the controller to proactively address potential performance issues before they impact the network, ensuring a more stable and consistent user experience. By anticipating and mitigating potential bottlenecks, the controller helps maintain the overall health and efficiency of the network.

In an embodiment the components of the RAN node optimization controller 206 may be implemented through an AI model. A function associated with the AI model may be performed through the memory 205 and the processor 203. The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that by applying a learning process to a plurality of learning data, a predefined operating rule or AI model of a desired characteristic is made. The learning may be performed in a device itself in which AI, according to an embodiment of the disclosure, is performed and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Whilst FIG. 2 depicts the hardware components of the consumer device 201, it should be noted that alternative embodiments are not confined to these elements. The consumer device 201 may comprise a greater or lesser number of hardware components in other embodiments. Additionally, the labels or names assigned to these elements are purely for illustrative purposes and do not restrict the scope of the disclosure. Furthermore, it is possible for one or more components to be merged together to perform the same or a substantially similar function.

In the context of 5G technology, the consumer device 201 and the producer device 101 refer to two distinct categories of devices based on their roles within the wireless network. The consumer devices 201 are typically an operational support system (OSS) or any functional entity at operations, administration, and maintenance (OAM) of the operator or the core network. In an embodiment of the disclosure, the consumer devices 201 include any OSS entity responsible for performance of the gNB or a NSSMF.

On the other hand, the producer devices 101 are those that generate and provide network services or data to the 5G ecosystem. These devices are integral to the functioning and optimization of the 5G network. Examples of the producer devices 101 include base stations, network servers, and edge computing nodes. These devices facilitate the transmission, processing, and management of data across the network. For instance, a 5G base station that transmits data to and from the network servers and user devices, or an edge computing node that processes data locally to reduce latency, are considered the producer devices 101. In essence, while the producer devices 101 utilize the network services, the producer devices 101 enable and sustain these services, ensuring seamless and efficient network operations.

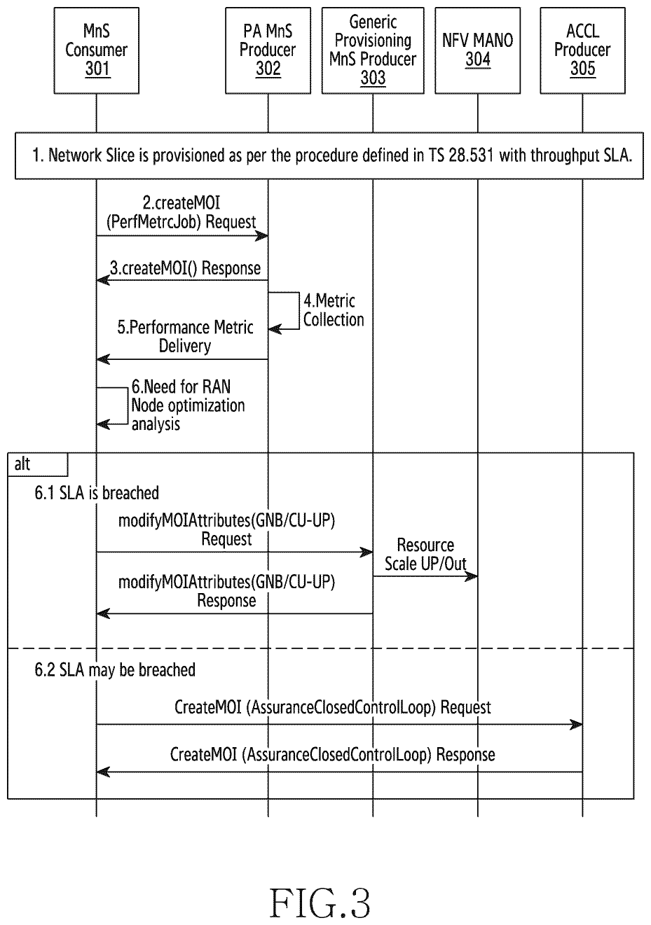

FIG. 3 illustrates a sequence diagram that illustrates a method for a RAN node optimization in a wireless network according to an embodiment of the disclosure.

Referring to FIG. 3, at operation 1, network slice is provisioned between the consumer device 201 and the producer device 101 as per the procedure defined in TS 28531 with throughput service-level agreements (SLA) as provided in the service profile.

At operation 2, a MnS consumer 301 sends the createMOI request to a performance assurance (PA) MnS producer 302. The createMOI request includes a PerfMetricJob that represents the performance metric production job. To activate the production of the specified performance metrics, the MnS consumer 301 needs to create the PerfMetricJob instance on the PA MnS producer 302. Further, the createMOI request includes a plurality of attributes for the performance metrics.

At operation 3, the PA MnS producer 302 sends a createMOI response to the MnS consumer 301.

At operation 4, the PA MnS producer 302 performs the collection of the performance metrics at the gNB and the CU-UP end of the N3/NgU interface based on the plurality of attributes received in the createMOI request. The performance metrics comprise the measurements of the number of octets of the incoming GTP data packets on the N3/NgU interface from the UPF to the RAN, the measurements of the number of octets of the outgoing GTP data packets on the N3/NgU interface from the RAN to the UPF, KPI of the downstream throughput for a network slice, and KPI of the upstream throughput for a network slice at the gNB and the CU-UP end of the N3/NgU interface.

At operation 5, the PA MnS producer 302 delivers the collected performance metrics to the MnS consumer 301 to optimize the gNB configurations and the CU-UP configurations at the producer device 101 based on the performance metrics.

At operation 6, the MnS consumer 301 checks for the need of the RAN node optimization based on the performance metrics received from the PA MnS producer 302.

At operation 6.1, when the MnS consumer 301 determines that the SLA is breached or the upstream throughput and the downstream throughput is less than a target value based on the performance metrics, the MnS consumer 301 sends the reconfiguration request to a generic provisioning MnS producer 303 of the producer device 101 to modify or update MOI attributes of the gNB and the CU-UP to scale up/out the gNB/CU-UP resources. The generic provisioning MnS producer 303 then interacts with NFV MANO 304 as appropriate. The generic provisioning MnS producer 303 interacts with NFV MANO 302 as defined in TS 28526. The modifyMOIAttributes response is sent from the generic provisioning MnS producer 303 to the MnS consumer 301.

At operation 6.2, when the MnS consumer 301 predicts that the SLA may be breached or the upstream throughput and the downstream throughput will be reduced to less than a target value based on the performance metrics, the MnS consumer 301 sends a request message to create ACCL to an ACCL producer device 305 of the producer device 101. An assurance goal will be set to initial throughput SLA as provided in the service profile in operation 301. The createMOI response is sent from the ACCL producer 305 to the MnS consumer 301 indicating the successful creation of the closed control loop. The created CCL will work to assure the throughput goal as defined in TS 28536.

Hence, when the provisioning MnS consumer 301 is informed about the throughput at the gNB/CU-UPs on the N3/NgU interface based on the SLA, the provisioning MnS consumer 301 optimizes the gNB configurations and CU-UP configurations at the producer device 101.

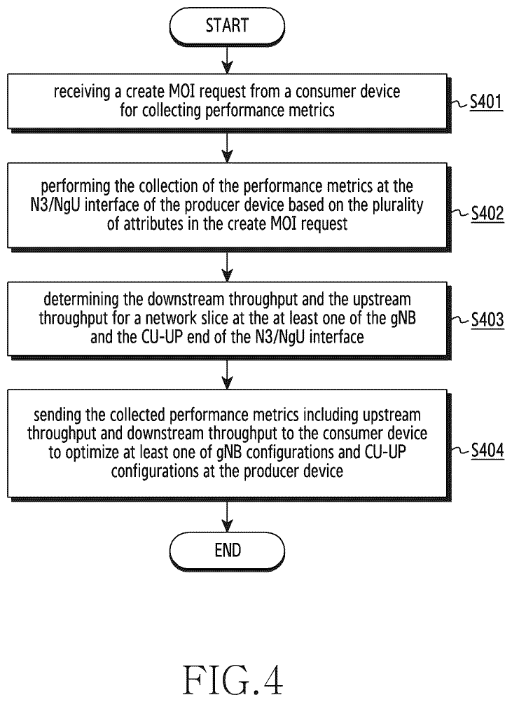

FIG. 4 is a flow diagram that illustrates a method for a RAN node optimization by a producer device in a wireless network according to an embodiment of the disclosure.

Referring to FIG. 4, at operation S401, the producer device 101 receives the create MOI request for collecting performance metrics from the consumer device 201. The create MOI request comprises the plurality of attributes for collecting the performance metrics, wherein the plurality of attributes for collecting the performance metrics comprises an objectInstances, a reportingCtrl, performanceMetrics, and a granularityPeriod.

At operation S402, the producer device 101 performs the collection of the performance metrics at the gNB and the CU-UP end of the N3/NgU interface of the producer device 101 based on the plurality of attributes received in the create MOI request. The performance metrics comprise measurements and KPIs collected at the gNB and the CU-UP end of the N3/NgU interface.

In an embodiment of the disclosure, the measurements comprise a measurement name representing the number of octets of the incoming GTP data packets and outgoing GTP data packets on the N3/NgU interface at the gNB and the CU-UP end, wherein the incoming GTP data packets and the outgoing GTP data packets are generated by a GTP-U protocol entity on the N3/NgU interface. The collection method for the measurement is cumulative counter (CC), and the measurement is valid for a packet switching network.

In an embodiment of the disclosure, the producer device 101 determines whether a condition for the measurements is met, wherein the condition for the measurements comprises a reception and a transmission of a GTP-U data PDU by the gNB and the CU-UP on the N3/NgU interface. The producer device 101 performs the measurements at the gNB and the CU-UP end of the N3/NgU interface when the condition is met.

In an embodiment of the disclosure, the producer device 101 splits the measurements into sub-counters per S-NSSAI. Each of the measurements is a single integer value when the number of the measurements is equal to one. The number of measurements is equal to the number of supported S-NSSAIs when optional S-NSSAI sub-counter measurements are performed.

In an embodiment of the disclosure, the KPI information comprises a KPI name representing the downstream throughput and the upstream throughput of a network slice instance at the gNB and the CU-UP end on the N3/NgU interface.

Measurement definition template is defined in clause 33 of TS 32.404, and KPI definition template is defined in clause 5 of TS 28.554. In an embodiment of the disclosure, the proposed measurements and KPIs description as per the _standard template include:

1. Number of Octets of Incoming GTP Data Packets on the N3/NgU Interface, from UPF to RAN:
a) This measurement provides the number of octets of incoming GTP data packets on the N3/NgU interface at gNB/CU-UP end, which have been generated by the GTP-U protocol entity on the N3/NgU interface. The measurement can optionally be split into sub-counters per S-NSSAI.
b) CC
c) Reception of a GTP-U data PDU by the gNB/CU-UP on the N3/NgU interface from UPF.
d) Each measurement is a single integer value, the number of measurements is equal to one. If the optional S-NSSAI sub-counter measurements are performed, the number of measurements is equal to the number of supported S-NSSAIs.
e) GTP. InDataOctN3gNB and optionally GTP. InDataOctN3gNB.SNSSAI, where SNSSAI identifies the S-NSSAI.
f) EP_NgU, EP_N3
g) Valid for packet switching
h) 5GS
   2. Number of Octets of Outgoing GTP Data Packets on the N3/NgU Interface, from RAN to UPF:
a) This measurement provides the number of octets of outgoing GTP data packets on the N3/NgU interface at gNB/CU-UP end, which have been generated by the GTP-U protocol entity on the N3/NgU interface. The measurement can optionally be split into sub-counters per S-NSSAI.
b) CC
c) Transmission of a GTP-U data PDU by the gNB/CU-UP on the N3/NgU interface to the UPF.
d) Each measurement is a single integer value, the number of measurements is equal to one. If the optional S-NSSAI sub-counter measurements are performed, the number of measurements is equal to the number of supported S-NSSAIs.
e) GTP.OutDataOctN3gNB and optionally GTP.OutDataOctN3gNB.SNSSAI, where SNSSAI identifies the S-NSSAI.
f) EP_NgU, EP_N3
g) Valid for packet switching
h) 5GS

### 3. Downstream Throughput for a Network Slice at gNB

a) DlThroughputNSgNBN3
b) This KPI describes the downstream throughput of a network slice instance at gNB/CU-UP end on the N3/NgU interface. It is obtained by measuring the total number of downstream octets provided over N3/NgU interface from UPF to NG-RAN, related to the single network slice, divided by the granularity period (in milliseconds). The KPI unit is kbit/s and the KPI type is MEAN.
c)

$$D 1 {ThroughputNS}_{gNBN 2} = \frac{{\sum }_{gNB} GTP . InDataOctN 3 gNB . SNSSAI}{granularityPeriod} \times 8$$

d) NetworkSlice, SubNetwork

### 4. Upstream Throughput for the Network Slice at the gNB:

a) UlThroughputNSgNBN3
b) This KPI describes the upstream throughput of a network slice instance at gNB/CU-UP end on the N3/NgU interface. It is obtained by measuring the total number of upstream octets provided over N3/NgU interface from NG-RAN to UPF, related to the single network slice, divided by the granularity period (in milliseconds). The KPI unit is kbit/s and the KPI type is MEAN.
c)

$$U 1 {ThroughputNS}_{gNBN 2} = \frac{{\sum }_{gNB} GTP . OutDataOctN 3 gNB . SNSSAI}{granularityPeriod} \times 8$$

d) NetworkSlice, SubNetwork.

In an embodiment of the disclosure, the granularity period is any time period of choice of the operator during which the operator wants to calculate the throughput KPI. At operation S403, the producer device 101 determines the downstream throughput and the upstream throughput for a network slice at the gNB and the CU-UP end of the N3/NgU interface. The producer device 101 determines a KPI name representing the downstream throughput of the network slice instance at the gNB and CU-UP end on the N3/NgU interface. Further, the producer device 101 determines the total number of downstream octets of the GTP data packets provided over the N3/NgU interface from the UPF to the RAN related to the single network slice. The producer device 101 divides the determined total number of downstream octets of the GTP data packets by a predetermined period to determine the downstream throughput.

In an embodiment of the disclosure, the producer device 101 determines a KPI name representing the upstream throughput of the network slice instance at the gNB and CU-UP end on the N3/NgU interface. Further, the producer device 101 determines the total number of upstream octets of the GTP data packets provided over the N3/NgU interface from the UPF to the RAN related to the single network slice. The producer device 101 divides the determined total number of upstream octets of the GTP data packets by a predetermined period to determine the upstream throughput.

At operation S404, the producer device 101 sends the collected performance metrics, including the upstream throughput and the downstream throughput, to the consumer device 201 to optimize the gNB configurations and the CU-UP configurations at the producer device 101.

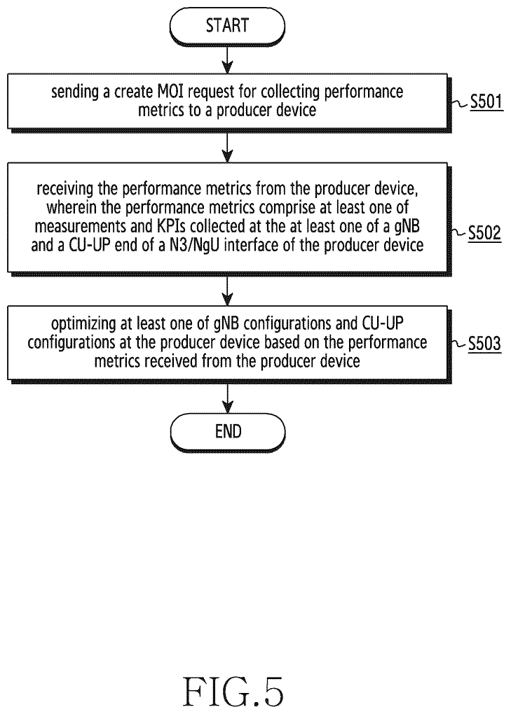

FIG. 5 is a flow diagram that illustrates a method for a RAN node optimization by a consumer device in a wireless network according to an embodiment of the disclosure.

Referring to FIG. 5, at operation S501, the consumer device 201 sends the create MOI request for collecting the performance metrics to the producer device 101. The create MOI request comprises the plurality of attributes for collecting the performance metrics, wherein plurality of attributes for collecting the performance metrics comprises an objectInstances, a reportingCtrl, a performanceMetrics, and a granularityPeriod.

At operation S502, the consumer device 201 receives the performance metrics from the producer device 101, wherein the performance metrics comprises a measurement of number of octets of incoming GTP data packets on the N3/NgU interface from a UPF to the RAN, measurement of number of octets of outgoing GTP data packets on the N3/NgU interface from the RAN to the UPF, KPI of a downstream throughput for a network slice, and KPI of an upstream throughput for a network slice at the gNB and the CU-UP end of the N3/NgU interface.

At operation S503, the consumer device 201 optimizes the gNB configurations and the CU-UP configurations at the producer device 101 based on the performance metrics received from the producer device 101.

In an embodiment of the disclosure, the consumer device 201 determines that the upstream throughput and the downstream throughput is less than the target value based on the performance metrics. The consumer device 201 sends a reconfiguration request to the producer device 101 to modify or update MOI attributes of the gNB and the CU-UP when the upstream throughput and the downstream throughput is less than the target value.

In an embodiment of the disclosure, the consumer device 201 predicts that the upstream throughput and the downstream throughput will be reduced to less than the target value based on the performance metrics. The consumer device 201 sends a request message to create ACCL to the producer device 101 when the upstream throughput and/or downstream throughput is predicted to be reduced to less than the target value.

The various actions, acts, blocks, steps, or the like in FIGS. 4 and 5 are performed in the order presented, in a different order or simultaneously. Further, in some embodiments of the disclosure, some of the actions, acts, blocks, steps, or the like are omitted, added, modified, skipped, or the like without departing from the scope of the proposed method.

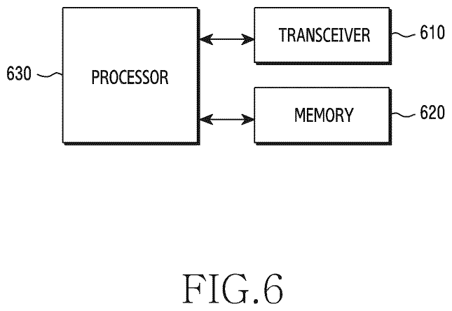

FIG. 6 illustrates a structure of a base station according to an embodiment of the disclosure.

As shown in FIG. 6, the base station according to an embodiment may include a transceiver 610, a memory 620, and a processor 630. The transceiver 610, the memory 620, and the processor 630 of the base station may operate according to a communication method of the base station described above. However, the components of the base station are not limited thereto. For example, the base station may include more or fewer components than those described above. In addition, the processor 630, the transceiver 610, and the memory 620 may be implemented as a single chip. Also, the processor 630 may include at least one processor. Furthermore, the base station of FIG. 6 corresponds to the producer device of the FIG. 1 or the consumer device of the FIG. 2.

The transceiver 610 collectively refers to a base station receiver and a base station transmitter, and may transmit/receive a signal to/from a terminal (UE) or a network entity. The signal transmitted or received to or from the terminal or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the base station. Also, the memory 620 may store control information or data included in a signal obtained by the base station. The memory 620 may be a storage medium, such as read-only memory (ROM), random access memory (RAM), a hard disk, a CD-ROM, and a DVD, or a combination of storage media.

The processor 630 may control a series of processes such that the base station operates as described above. For example, the transceiver 610 may receive a data signal including a control signal transmitted by the terminal, and the processor 630 may determine a result of receiving the control signal and the data signal transmitted by the terminal.

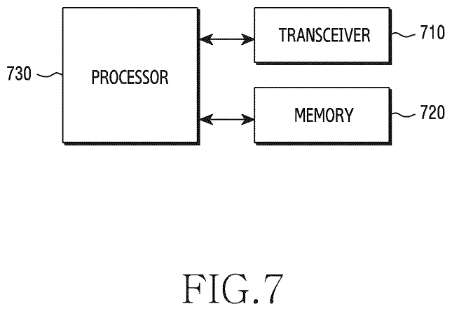

FIG. 7 illustrates a structure of a network entity according to an embodiment of the disclosure.

As shown in FIG. 7, the network entity according to an embodiment may include a transceiver 710, a memory 720, and a processor 730. The transceiver 710, the memory 720, and the processor 730 of the network entity may operate according to a communication method of the network entity described above. However, the components of the network entity are not limited thereto. For example, the network entity may include more or fewer components than those described above. In addition, the processor 730, the transceiver 710, and the memory 720 may be implemented as a single chip. Also, the processor 730 may include at least one processor. Furthermore, the network entity of FIG. 7 corresponds to the producer device of the FIG. 1 or the consumer device of the FIG. 2.

The transceiver 710 collectively refers to a network entity receiver and a network entity transmitter, and may transmit/receive a signal to/from a terminal (UE), a base station or another network entity. The signal transmitted or received to or from the terminal, a base station, or another network entity may include control information and data. The transceiver 10 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the network entity. Also, the memory 720 may store control information or data included in a signal obtained by the network entity. The memory 720 may be a storage medium, such as read-only memory (ROM), random access memory (RAM), a hard disk, a CD-ROM, and a DVD, or a combination of storage media.

The processor 730 may control a series of processes such that the network entity operates as described above. For example, the transceiver 710 may receive a data signal including a control signal transmitted by the terminal or the base station, and the processor 730 may determine a result of receiving the control signal and the data signal transmitted by the terminal or the base station.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a base station (BS) in a wireless communication system, the method comprising:
measuring downstream throughput on an interface between the BS and a user plane function (UPF) entity; and
measuring upstream throughput on the interface between the BS and the UPF entity.

2. The method of claim 1, wherein the measuring of the downstream throughput includes measuring a number of octets of incoming data packets on the interface.

3. The method of claim 2, wherein the incoming data packets include GPRS tunneling protocol (GTP) data packets based on a GTP-U (user plane) protocol.

4. The method of claim 1, wherein the measuring of the upstream throughput includes measuring a number of octets of outgoing data packets on the interface.

5. The method of claim 4, wherein the outgoing data packets include GTP data packets based on a GTP-U protocol.

6. The method of claim 1, wherein a first number of the measurement of downstream throughput and a second number of the measurement of upstream throughput are equal to one.

7. The method of claim 1, wherein the upstream throughput and the downstream throughput are measured per a network slice.

8. The method of claim 1, wherein the upstream throughput and the downstream throughput are measured for a granularity period.

9. The method of claim 1, wherein the BS includes a gNodeB CU (central unit)-UP (user plane).

10. The method of claim 9, wherein the interface includes an NgU interface.

11. A base station (BS) in a wireless communication system, the BS comprising:
a transceiver; and
a controller coupled with the transceiver and configured to:
measure downstream throughput on an interface between the BS and a user plane function (UPF) entity; and
measure upstream throughput on the interface between the BS and the UPF entity.

12. The BS of claim 11, wherein the controller further configured to:
measure a number of octets of incoming data packets on the interface.

13. The BS of claim 12, wherein the incoming data packets include GPRS tunneling protocol (GTP) data packets based on a GTP-U (user plane) protocol.

14. The BS of claim 11, wherein the controller further configured to:
measure a number of octets of outgoing data packets on the interface.

15. The BS of claim 14, wherein the outgoing data packets include GTP data packets based on a GTP-U protocol.

16. The BS of claim 11, wherein a first number of the measurement of downstream throughput and a second number of the measurement of upstream throughput are equal to one.

17. The BS of claim 11, wherein the upstream throughput and the downstream throughput are measured per a network slice.

18. The BS of claim 11, wherein the upstream throughput and the downstream throughput are measured for a granularity period.

19. The BS of claim 11, wherein the BS includes a gNodeB or CU-UP.

20. The BS of claim 19, wherein the interface includes an NgU interface.
